(19) United States
(12) Patent Application Publication
(10) Pub. No.: US 2005/0168764 A1
(43) Pub. Date: Aug. 4, 2005

(54) Data processor, data processing method, storage medium for storing computer-readable program, and program

(75) Inventor: Shinichi Yamamura, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/019,345

(22) Filed: Dec. 21, 2004

(30) Foreign Application Priority Data
Jan. 30, 2004 (JP) 2004-022495

(51) Int. Cl. G06F 3/12; H04N 1/40; G06K 15/02

(52) U.S. Cl. 358/1.13; 358/2.1; 358/1.16

(57) ABSTRACT

The printing mode for each page of a document can be efficiently selected at a preferable timing. A printer driver identifies a spooled intermediate code as color data or monochrome data, based on selected criteria. Based on the identification results, a page that has been identified as being ambiguous is displayed on a screen. The printing mode of the ambiguous page can be changed. Then, the change of the printing mode is confirmed. After the change is confirmed, the intermediate code is printed in accordance with the confirmed printing mode.

### BACKGROUND OF THE INVENTION

1. Field of the Invention

The present invention relates to a data processor capable of generating printable data from image data via a printer driver capable of communicating with a printer, a method for processing the data, a storage medium for storing a program readable by a computer, and the program.

2. Description of the Related Art

Since color printers have come into widespread use just recently, documents including color and monochrome data produced by desktop publishing (DTP) apparatuses, such as personal computers, word processors, and work stations, are often printed out from printers.

Some of the recently known color printers have a color printing mode and a monochrome printing mode. In monochrome-printing mode, the processing speed is increased. For a coin-operated printer, the price of a color image printout is set at a higher price than that of a monochrome image printout.

For a print service system for printing out color images, only image data having the same values for each RGB (red-green-blue) value is identified as monochrome image data.

Spool data of the document data transferred from the DTP apparatus, such as a personal computer, a word processor, or a work station, is checked by a printer driver. In accordance with the check results, the printer driver automatically switches between the color printing mode and the monochrome printing mode. Image data having exactly the same value for each RGB value for the three primary colors (red, green, and blue) is identified as monochrome image data. However, by using such a criterion for identifying whether an image is a color image or a monochrome image, even if the image appears monochrome to the human eye, if the RGB values are not exactly the same, the image will be identified as a color image and a user may be charged for the price of a color image printout to print out an image that appears to be monochrome. Japanese Patent Laid-Open No. 10-285421 discloses a technology for automatically identifying whether an image is color or monochrome by checking the spool data with a printer driver.

To prevent the printer driver from identifying an image that appears to be monochrome as a color image, the criterion for identifying whether an image is color or monochrome may be relaxed. By doing this, however, a color image may be mistakenly identified as a monochrome image.

When such a mistake occurs, the black areas in the color image that should have been printed in a mixture of three different colors of ink (cyan, magenta, and yellow) (i.e., process gray) is printed in black ink only. Thus, the image becomes too bright, reducing the quality of the image.

### SUMMARY OF THE INVENTION

The present invention solves the above-mentioned problems by providing data processor, a method for processing data, a storage medium for storing a program readable by a computer, and a program that are capable of printing out pages of a document in a printing mode in accordance with a user's preference even when a printer driver automatically identifies the printing mode (color or monochrome printing mode) for each page of a document. A page including image data having equal RGB values is identified as a monochrome page. A page whose differences in the RGB values are below a predetermined value is identified as a monochrome page. However, in such a case, an identifier (flag) indicating that the page is ambiguously monochrome is added to the preview of the page before printing is carried out. If a user does not agree with the automatically selected printing mode (in this case, a monochrome printing mode), the user can change the printing mode on the preview screen.

A first aspect of the present invention is a data processor for processing print data generated from image data by a printer driver capable of communicating with a printer. The data processor includes: spool means (such as a spool file 303 illustrated in FIG. 3) for converting image data into intermediate code and temporarily storing the intermediate code in a storage unit, the intermediate code having a data format different from the print data; criterion selection means (such as a DETAILED SETTINGS window illustrated in FIG. 7) for selecting a criterion for identifying the intermediate code as color data or monochrome data; identification means (such as Step 503 illustrated in FIG. 6 performed by a printer driver 203 illustrated in FIG. 3) for identifying the intermediate code as color data or monochrome data based on the criterion selected by the criterion selection means and determining whether identification of the intermediate code is ambiguous; display-controlling means (such as previews illustrated in FIG. 10 by the printer driver 203 illustrated in FIG. 3) for displaying the intermediate code identified as being ambiguous by the identification means in a way that allows a user to select a printing mode for the intermediate code identified as being ambiguous; printing-mode selection means (such as a combo box CB1 illustrated in FIG. 10) for selecting a printing mode for the intermediate code that has been identified as being ambiguous, the intermediate code being displayed by the display-controlling means; and converting means (such as Step 802 illustrated in FIG. 13 and Step 804 illustrated in FIG. 14) for converting the intermediate code stored in the storage unit into print data in accordance with the printing mode selected by the printing-mode selection means.

Further features and advantages of the present invention will become apparent from the following description of exemplary embodiments (with reference to the attached drawings).

### BRIEF DESCRIPTION OF THE DRAWINGS

FIG. 1 is a block diagram of the structure of a printer control system according to a first embodiment of the present invention.

FIG. 2 illustrates the structure of modules for processing data at the host computer illustrated in FIG. 1.

FIG. 3 is a block diagram illustrating the structure of modules for a system that is an expansion of the system illustrated in FIG. 2.

FIG. 4 is a cross-sectional view of a color laser printer having a double-sided printing function according to an embodiment of a printer according to the present invention illustrated in FIG. 3.

FIG. 5 is an example of a page setup screen displayed on a CRT (cathode ray tube) of the host computer illustrated in FIG. 1.

FIG. 6 is a flow chart illustrating a first data processing sequence for a data processor according to the present invention.

FIG. 7 illustrates a detailed settings window of ambiguity displayed on the CRT of the host computer illustrated in FIG. 1.

FIG. 8 is a flow chart illustrating a second data processing sequence for a data processor according to the present invention.

FIG. 9 illustrates page objects of a document managed by a printer driver illustrated in FIGS. 2 and 3.

FIG. 10 illustrates previews for all pages of a document that have been identified as color or monochrome images displayed on a CRT of the host computer illustrated in FIG. 1.

FIG. 11 illustrates previews for pages of a document that have been identified as ambiguously monochrome images displayed on a CRT of the host computer illustrated in FIG. 1.

FIG. 12 illustrates a management table with page objects of a document managed by the printer driver illustrated in FIGS. 2 and 3.

FIG. 13 is a flow chart illustrating a third data processing sequence for a data processor according to the present invention.

FIG. 14 is a flow chart illustrating a fourth data processing sequence for a data processor according to the present invention.

FIG. 15 illustrates another management table with page objects of a document managed by the printer driver illustrated in FIGS. 2 and 3.

FIG. 16 is a schematic view of a memory map of a storage medium for storing various data processing programs readable by the image processor according to the present invention.

### DESCRIPTION OF THE EMBODIMENTS

Exemplary embodiments of the present invention will now be described with reference to the drawings.

### First Embodiment

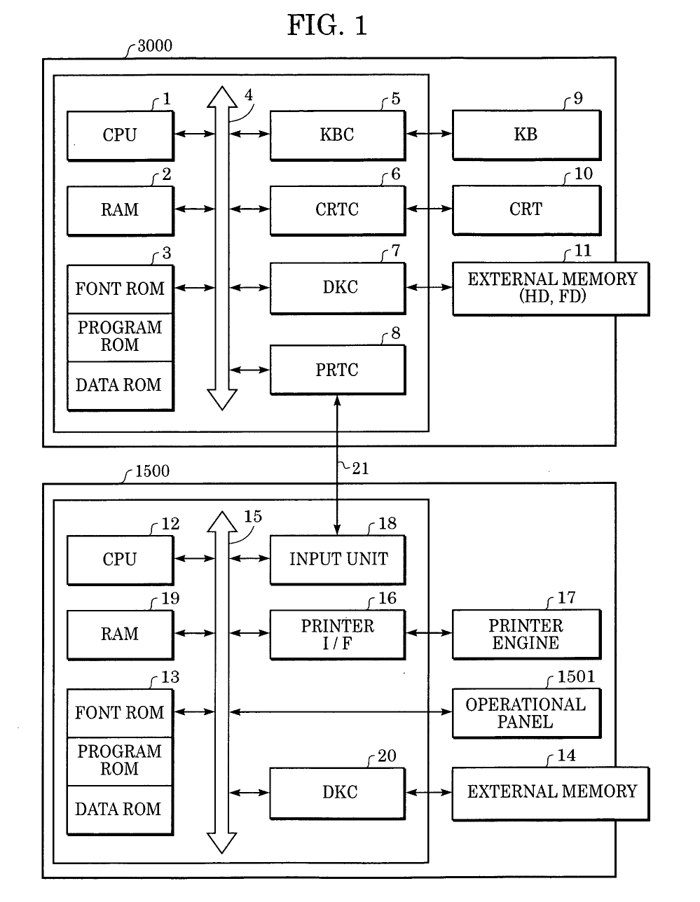

FIG. 1 is a block diagram of the structure of a printer control system according to a first embodiment of the present invention. The control system can be a single unit, a plurality of units, or a plurality of units connected via a network, such as a LAN (local area network) or a WAN (wide area network), as long as the functions according to the present invention can be executed.

FIG. 1 illustrates a host computer 3000 including a CPU (central processing unit) 1 for processing documents including graphics, images, text, and charts (including spreadsheets) based on a document processing program stored in a ROM (read-only memory) 3 for programs or an external memory 11. The CPU 1 totally controls each device connected to a system bus 4. The program ROM in the ROM 3 or the external memory 11 stores an operating system (OS) program for controlling the CPU 1. The ROM 3 also includes a font ROM that stores font data and a data ROM that stores various other data used when a document is processed. A RAM (random access memory) 2 functions as a main memory and a work area for the CPU 1.

A keyboard controller (KBC) 5 controls key input from a keyboard (KB) 9 or a pointing device (not depicted in the drawings). A CRT controller (CRTC) 6 controls a CRT display (CRT) 10. A disk controller (DKC) 7 controls access to the external memory 11 that is used for storing data (such as a boot program, various applications, font data, user files, editing files, and a print controlling command generating program (hereinafter referred to a ‘printer driver’)). The external memory may be, for example, a hard disk (HD) or a flexible disk (FD). A printer controller (PRTC) 8 is connected to a printer 1500 via a bi-directional interface (hereinafter referred to as an ‘interface’) 21 for controlling communication between the printer 1500 and the host computer 3000.

The CPU 1, for example, enables WYSIWYG (what you see is what you get) on the CRT 10 by rasterizing outline font data stored in a display data RAM defined on the RAM 2. The CPU 1 opens various windows according to commands input by operating a mouse cursor (not depicted in the drawings) on the CRT 10 and carries out various types of data processing. When printing, a user can open a window for printing preferences to select various settings for the printer driver including the settings for the printer and the printing mode.

The printer 1500 is controlled by a printer CPU (hereinafter referred to as a ‘CPU’) 12. The CPU 12 sends an image signal as output data to a printer engine 17 via a printer interface 16 connected to a system bus 15 based on a control program stored in a ROM 13 for programs or an external memory 14. The ROM 13 includes a program ROM portion, a font ROM portion and a data ROM portion. The program ROM portion of the ROM 13 stores control programs for the CPU 12. The font ROM portion of the ROM 13 stores font data used for generating the output data. The data ROM portion of the ROM 13 stores data used by the host computer when the printer is not connected to the external memory 14, such as a hard disk.

The CPU 12 is capable of communicating with the host computer 3000 via an input unit 18 and is capable of sending data in the printer to the host computer 3000. A RAM 19 functions as a main memory and a work area for the CPU 12. The memory capacity of the RAM 19 can be increased by connecting an optional RAM to an expansion port (not depicted in the drawings). Areas of the RAM 19 are used for expanding output data, storing environmental data, and as an NVRAM (non-volatile RAM). Access to the external memory 14, such as a hard disk (HD) or an IC (integrated circuit) card, is controlled by a memory controller (DKC) 20. The external memory 14 is connected to the printer 1500 as an option and is used to store font data, emulation programs, and form data. An operational panel 1501 includes switches and LED (light emitting diode) displays for carrying out operations.

The external memory 14 is not limited to one memory unit and may include a plurality of memory units. The external memory 14 may be a plurality of interconnected external memories including option cards that store internal fonts and programs for interpreting and different printer control languages. The external memory 14 may also include an NVRAM (not depicted in the drawings) for storing printer mode-setting data from the operation panel 1501.

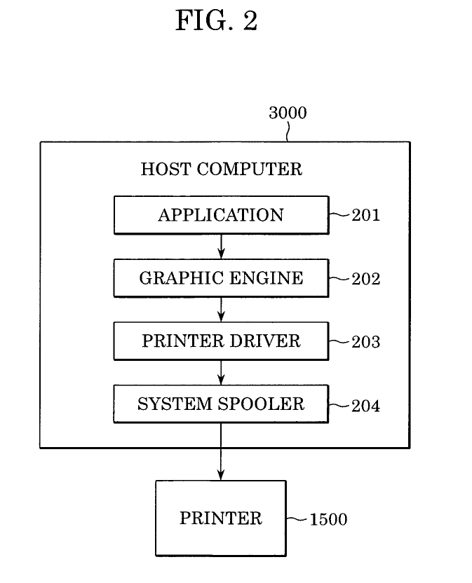

FIG. 2 illustrates the structure of modules for processing data at the host computer 3000 illustrated in FIG. 1. The components illustrated in FIG. 1 are represented by the same reference numerals as those used in FIG. 1. FIG. 2 illustrates a typical printing process in the host computer 3000 directly connected to the printer 1500 or indirectly connected to a printer 1500 via a network.

An application 201, a graphic engine 202, a printer driver 203, and a system spooler 204, illustrated in FIG. 2, are stored in the external memory 11 as files and are program modules that are loaded into the RAM 2 by the OS program or other modules using these modules.

The application 201 and the printer driver 203 can be added to the external memory 11 (i.e., hard disk) via a flexible disk (which is also considered as part of the external memory 11), a CD-ROM (compact disk—ROM) (not depicted in the drawings), or a network (not depicted in the drawings).

The application 201 stored in the external memory 11 is loaded into the RAM 2. However, when sending print data from the application 201 to the printer 1500, images are output via the graphic engine 202, which can also be loaded into the RAM 2.

The graphic engine 202 loads the printer driver 203 for each different printer from the external memory 11 into the RAM 2. The printer driver 203 converts the output from the application 201 into a control command for the printer 1500. This converted control command for the printer 1500 is sent to the printer 1500 via the system spooler 204 loaded into the RAM 2 by the OS program and via the interface 21.

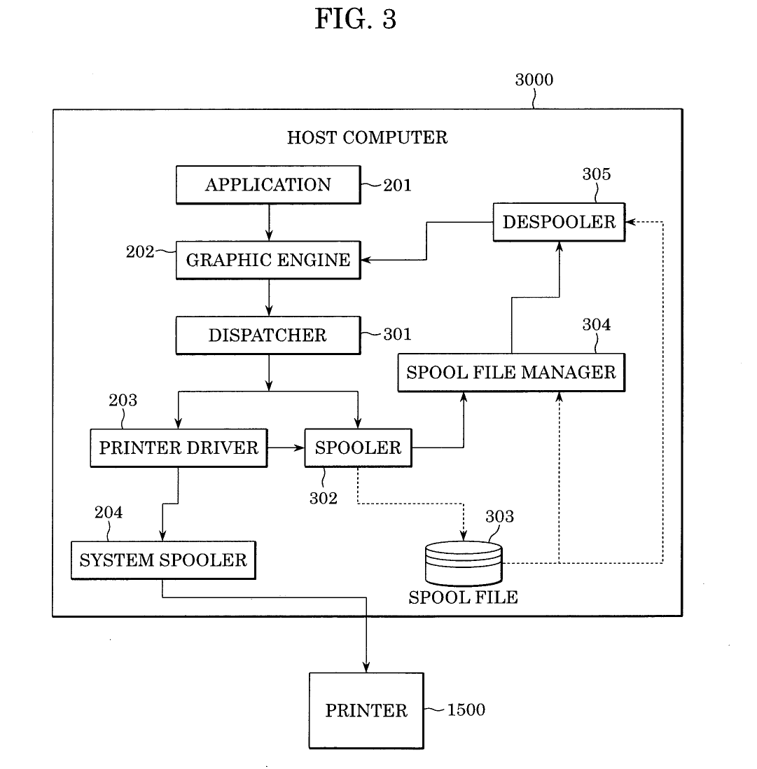

The printing system according to this embodiment includes the printer 1500 and the host computer 3000, as illustrated in FIG. 2. In this printing system, the print data from the application 201 is temporarily spooled as intermediate code data, as illustrated in FIG. 3.

FIG. 3 is a block diagram illustrating the structure of modules for a system that is an expansion of the system illustrated in FIG. 2. FIG. 3 corresponds to a case in which a spool file 303 including intermediate code data is generated when a print command is sent from the graphic engine 202 and printer driver 203.

In the system illustrated in FIG. 2, the application 201 is released from the printing process when the printer driver 203 finishes converting every print command from the graphic engine 202 into control commands for the printer 1500. In the system illustrated in FIG. 3, however, the application 201 is released from the printing process when a spooler 302 finishes converting every print command from the graphic engine 202 into intermediate code data and sending this intermediate code data to a spool file 303. Usually, the process illustrated in FIG. 3 requires less time compared to the process illustrated in FIG. 2. In the system illustrated in FIG. 3, the content of the spool file 303 can be modified. In this way, various functions not included in the application 201, such as enlarging and reducing the size of an image and printing a plurality of pages onto one sheet of paper, can be applied to the print data sent from the application 201.

To achieve the above, the system illustrated in FIG. 2 is extended into the system illustrated in FIG. 3 in which intermediate code data is spooled. Usually, the print data is modified through a window provided by the printer driver 203. Then, the printer driver 203 stores these modifications in the RAM 2 or the external memory 11. Details of the system illustrated in FIG. 3 are described next.

As illustrated in FIG. 3, in this extended processing system, a dispatcher 301 receives a print command from the graphic engine 202. If this print command is issued to the graphic engine 202 by the application 201, the dispatcher 301 loads the spooler 302 stored in the external memory 11 into the RAM 2 and sends the print command to the spooler 302 instead of to the printer driver 203. The spooler 302 converts the received print command into intermediate code data and sends this to the spool file 303.

The spooler 302 receives modifications concerning the print data from the printer driver 203 and stores these modifications in the spool file 303.

The spool file 303 is stored in the external memory 11 in a file format. However, the spool file 303 may be stored in the RAM 2. The spooler 302 loads a spool file manager 304 into the RAM 2 and informs the spool file manager 304 about the modifications stored in the spool file 303. Then, the spool file manager 304 determines whether printing can be performed in accordance with these modifications concerning the print data stored in the spool file 303.

If the spool file manager 304 determines that printing is possible using the graphic engine 202, a despooler 305 stored in the external memory 11 is loaded into the RAM 2. Then, the despooler 305 is commanded to process the intermediate code data included in the spool file 303 so that the intermediate code data can be printed out.

The despooler 305 processes the intermediate code included in the spool file 303 in accordance with the modifications stored in the spool file 303 and outputs the results via the graphic engine 202.

If the print command received by the dispatcher 301 from the graphic engine 202 is issued from the despooler 305 to the graphic engine 202, the dispatcher 301 sends the print command to the printer driver 203 instead of to the spooler 302.

The printer driver 203 generates a printer control command and sends this to the printer 1500 via the system spooler 204.

<Structure of Color Laser Beam Printer>

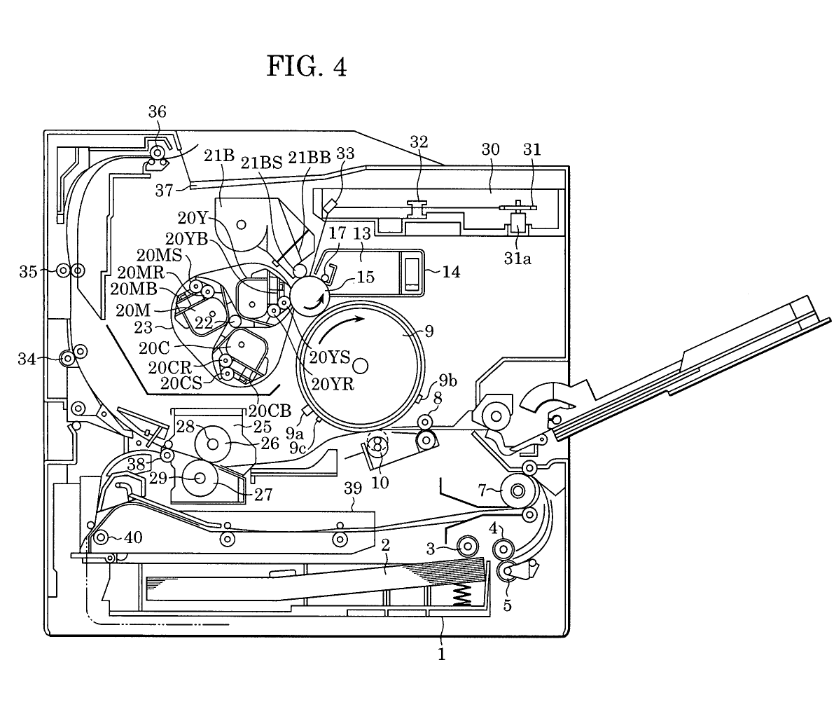

FIG. 4 is a cross-sectional view of an example of the printer 1500 illustrated in FIG. 1. The printer illustrated in FIG. 4 is a color laser printer having a double-sided printing function.

In the printer, illustrated in FIG. 4, a laser beam is modulated according to each set of image data for each color, yellow (Y), magenta (M), cyan (C), and black (B), based on the print data sent from the host computer 3000. This laser beam is reflected at a polygon mirror 31. The reflected laser beam is used for exposure-scanning of a uniformly charged photosensitive drum 15 to form an electrostatic latent image corresponding to the image data on the photosensitive drum 15. This electrostatic latent image is developed using toners of each color to form visible images. Then, multiple layer transfer of these visible images for each color to an intermediate transfer body 9 is carried out to form a visible color image. Furthermore, this visible color image is transferred onto a transfer material 2, such as a sheet of recording paper, and is, then, fixed to this transfer material 2. An image forming unit for controlling the above-described process includes a drum unit 13 including the photosensitive drum 15, a primary charging unit including a contact charging roller 17, a cleaning unit, a developing unit, the intermediate transfer body 9, a paper feeding unit including a paper cassette 1 and various rollers 3, 4, 5, and 7, a transfer unit including a transfer roller 10, and a fixing unit 25.

The drum unit 13 is a single unit including the photosensitive drum (photosensitive body) 15 and a cleaner container 14. The cleaner container 14 is a cleaner holder having a cleaning mechanism. The drum unit 13 is detachable from the printer body and can be easily replaced with a new one when the life of the photosensitive drum 15 expires. The photosensitive drum 15 is, for example, an aluminum cylinder having an organic photoconductive layer on the outer circumference. The photosensitive drum 15 is rotatably supported by the cleaner container 14. The photosensitive drum 15 is rotated by a driving force transmitted from a driving motor (not depicted in the drawing). The driving motor rotates the photosensitive drum 15 in the counter-clockwise direction in accordance with the image forming operation. The surface of the photosensitive drum 15 is selectively irradiated with the laser beam in accordance with the image data to form an electrostatic latent image corresponding to the image data. At a scanner 30, the laser beam modulated according to the image data is reflected by the polygon mirror 31 rotated by a motor 31a in synchronization with the horizontal synchronized signal of the image signal. This reflected laser beam travels through a lens 32 and is reflected at a mirror 33 to be used for exposure-scanning of the photosensitive drum 15.

The developing unit includes three color developing units 20Y, 20M, and 20C for developing yellow, magenta, and cyan, respectively, and a black developing unit 21B for developing black. These developing units 20Y, 20M, 20C and 21B make the electrostatic latent image visible using a developer, such as toner. The developing units 20Y, 20M, 20C, and 21B have sleeves 20YS, 20MS, 20CS, and 21BS, respectively. Application blades 20YB, 20MB, 20CB, and 21BB are pressed onto the outer circumferences of the sleeves 20YS, 20MS, 20CS and 21BS, respectively. Application rollers 20YR, 20MR, and 20CR are provided on the color developing units 20Y, 20M, and 20C, respectively.

The black developing unit 21B is detachable from the printer body. The color developing units 20Y, 20M, and 20C are detachable from a developing rotor 23 having a rotary shaft 22.

The sleeve 21BS of the black developing unit 21B is slightly apart (for example, about 300 μm) from the photosensitive drum 15. The black developing unit 21B includes a delivering unit for delivering the toner to the photosensitive drum 15. The black developing unit 21B electrically charges the toner with a frictional charge generated while applying the toner to the outer circumference of the sleeve 21BS rotating in the clockwise direction with the application blade 21BB. By applying a development bias voltage to the sleeve 21BS, the photosensitive drum 15 is developed in accordance with the electrostatic latent image to form a visible image with black toner.

The color developing units 20Y, 20M, and 20C rotate in cooperation with the developing rotor 23 when forming an image. While the color developing units 20Y, 20M, and 20C are in rotation, the corresponding sleeves 20YS, 20MS, and 20CS oppose the photosensitive drum 15 with an interval of about 300 μm. In this way, the color developing units 20Y, 20M, and 20C stop at predetermined positions opposing the photosensitive drum 15 so as to form a visible image on the photosensitive drum 15.

When forming a color image, the developing rotor 23 rotates every time the intermediate transfer body 9 completes one revolution. Subsequently, the yellow developing unit 20Y, the magenta developing unit 20M, the cyan developing unit 20C, and the black developing unit 21B carry out the developing process in sequence. The intermediate transfer body 9 completes four revolutions to form visible images in each color of toner (yellow, magenta, cyan, and black) in sequence. As a result, a full-visible color image is formed on the intermediate transfer body 9.

The intermediate transfer body 9 is in contact and rotates in cooperation with the photosensitive drum 15. The intermediate transfer body 9 rotates in the clockwise direction when a color image is to be formed so as to receive the multiple (i.e., four) layers of the visible images from the photosensitive drum 15. The transfer roller 10, described later, comes into contact with the intermediate transfer body 9 to deliver the transfer material 2 between the transfer roller 10 and the intermediate transfer body 9. While the transfer material 2 is delivered, the multiple layer transfer of the visible color image on the intermediate transfer body 9 is carried out to the transfer material 2. On the outer circumference of the intermediate transfer body 9, a TOP sensor 9a and an RS sensor 9b for detecting the position of the intermediate transfer body 9 in respect to the rotational direction and a density sensor 9c for detecting the density of the toner image transferred onto the intermediate transfer body 9 are provided.

The transfer roller 10 includes a transfer charger that can be removed away from the photosensitive drum 15. The transfer roller 10 may be a metal shaft that has been wound around with a moderately resistive elastic foam.

The transfer roller 10, as illustrated in FIG. 4 by a solid line, is separated from the intermediate transfer body 9 in a downwards direction while multiple layer transfer of the visible color image is carried out so as to not disrupt the image formation. After a full-color (four color) visible image is formed on the intermediate transfer body 9, the transfer roller 10 is moved upwards to the position indicated by the dotted line in the drawing by a cam (not depicted in the drawing) in accordance with the timing that the visible color image is transferred onto the transfer material 2. In this way, the transfer roller 10 is pressed against the intermediate transfer body 9 with a predetermined pressure as the transfer material 2 is interposed between the transfer roller 10 and the intermediate transfer body 9. At the same time, a bias voltage is applied to the transfer roller 10 to transfer the visible color image on the intermediate transfer body 9 onto the transfer material 2.

The fixing unit 25 fixes the visible color image transferred onto the transfer material 2 while delivering the transfer material 2. The fixing unit 25 includes a fixing roller 26 for heating the transfer material 2 and a pressure roller 27 for pressing the transfer material 2 against the fixing roller 26. The fixing roller 26 and the pressure roller 27 are hollow cylinders having heaters 28 and 29, respectively, disposed inside the cylinders. In other words, while the fixing roller 26 and the pressure roller 27 deliver the transfer material 2 having the visible color image, heat and pressure are applied to the transfer material 2 so as to fix the toner to the surface of the transfer material 2.

After the visible image is fixed to the transfer material 2, ejection rollers 34, 35, and 36 eject the transfer material 2 into the ejection unit 37. Accordingly, the image forming operation is completed. The waste toner remaining after the toner image formed on the photosensitive drum 15 was transferred onto the intermediate transfer body 9 and the waste toner remaining after the four-color image on the intermediate transfer body 9 was transferred onto the transfer material 2 are collected into the cleaner container 14.

The transfer material (i.e., a sheet of recording paper) 2 used for printing is picked up from a paper tray 1 by a paper feeding roller 3 and delivered between the intermediate transfer body 9 and the transfer roller 10. While the transfer material 2 passes through the intermediate transfer body 9 and the transfer roller 10, the color image is recorded on the transfer material 2 with toner. Then, this toner image is fixed as the transfer material 2 passes through the fixing unit 25. When printing on one side of the sheet of paper, a guide 38 provides a delivery path for guiding the sheet of paper to the paper ejection unit. For printing on both sides of the sheet of paper, the guide 38 provides a delivery path for guiding the sheet of paper to the double-sided unit.

The sheet of recording paper guided through the double-sided unit is sent (along the delivery path indicated by the double-dashed line in the drawing) to the lower portion of the paper tray 1 by the delivery roller 40 and, then, is delivered in the opposite direction to a double-sided tray 39. The front and back sides of the sheet of paper delivered to the double-sided tray 39 are reversed with respect to the sheet of paper disposed on the paper tray 1. Also, the front edge and the rear edge in the delivery direction are reversed. By transferring and fixing a toner image onto the sheet of paper disposed in this direction, images can be printed onto both sides of the sheet of paper.

The color/monochrome identification process according to this embodiment will now be described in detail.

When a user clicks on an ACQUIRE CONFIGURATION DATA button on a printing dialog screen via an operating input device, such as a pointing device, the printer 1500 is inquired about its specifications.

In this inquiry process, it is determined whether or not the printer 1500 is capable of switching between a color printing mode and a monochrome printing mode for each page included in the image data.

Whether or not the printer 1500 is capable of switching between a color printing mode and a monochrome printing mode can be determined by storing a list of printer names and their specifications in memory (for example, the external memory 11) included in the printer driver 203. This list can be referred to when looking up the specification for the printer 1500. In this way, it is easier to determine whether or not the printer 1500 is capable of switching between color and monochrome printing modes than actually communicating with the printer 1500 to inquire its specification under a multi-vendor environment.

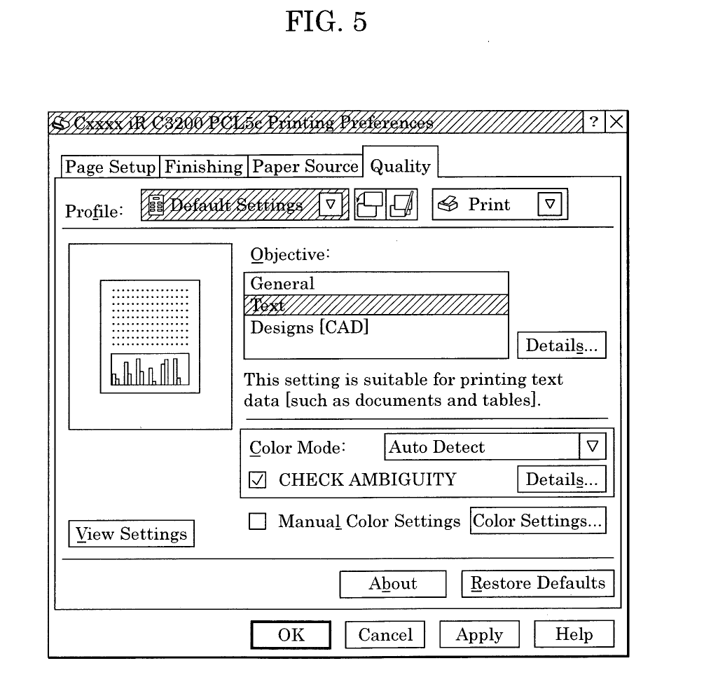

If the printer 1500 is determined to be capable of switching between color and monochrome printing modes, the CPU 1 controls the CRT 10 of the host computer 3000 so that, for example, an AUTO DETECT item is selected for a COLOR MODE combo box in a PRINTING PREFERENCES window displayed on the CRT 10, as illustrated in FIG. 5. In this way, for each page included in the image data, the printing mode is automatically switched between color and monochrome printing modes.

FIG. 5 is an example of a page setup screen displayed on the CRT 10 of the host computer 3000.

If the printer 1500 is determined as being incapable of switching between color and monochrome printing modes for each page, the AUTO DETECT item is not displayed in the COLOR MODE combo box of the window illustrated in FIG. 5. Instead, “Color” indicating that color printing will be carried out or “Mono” indicating that monochrome printing will be carried out is displayed in the COLOR MODE combo box.

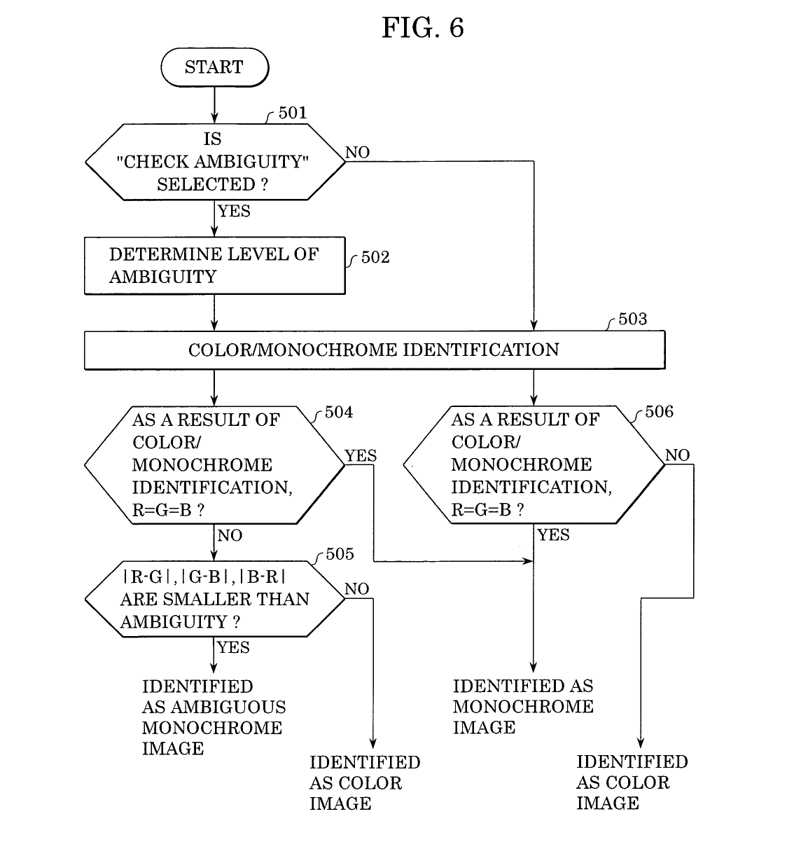

FIG. 6 is a flow chart illustrating a first data processing sequence for a data processor according to the present invention. More specifically, the flow chart illustrates the steps of an image processing sequence including steps for identifying whether the image is a color image, a monochrome image, or an ambiguously monochrome image. The sequence includes Steps 501 to 506.

In Step 501, the CPU 1 confirms whether or not a CHECK AMBIGUITY box is checked in the PRINTING PREFERENCES window illustrated in FIG. 5. If the CPU 1 determines that the CHECK AMBIGUITY box has not been checked, the sequence proceeds to Step 503. In Step 503, only an image having the exact same value for each RGB value for the three primary colors (red, green, and blue) is identified as a monochrome image. If the RGB values are not exactly the same, the image is identified as a color image.

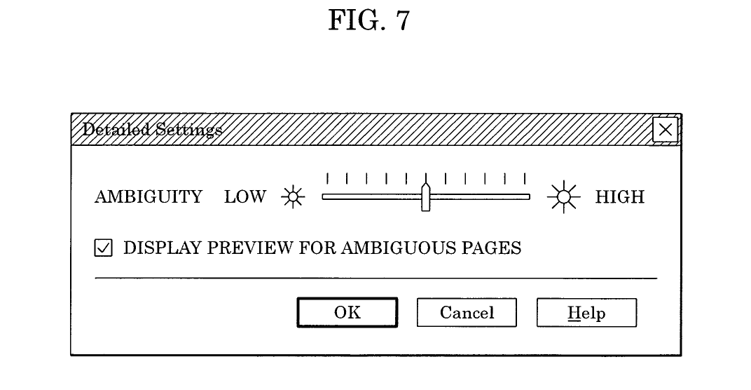

On the other hand, if the CPU 1 determines that the CHECK AMBIGUITY box has been checked, the sequence proceeds to Step 502. In Step 502, the level of ambiguity is selected by operating an AMBIGUITY slide bar in a DETAILED SETTINGS window, as illustrated in FIG. 7. Then, in Step 503, the image is identified as a color image or a monochrome image.

FIG. 7 illustrates a window for detailed settings of ambiguity displayed on the CRT 10 of the host computer 3000.

In this embodiment, an image in which the differences in the RGB values are less than a predetermined value is identified as a monochrome image. If the RGB values are not exactly the same, the image is identified as a color image.

More specifically, if R=G=B, the image is identified as a monochrome image. If |R-G|<N, |G-B|<N, and |B-R|<N, the image is identified as an ambiguously monochrome image. If the image does not satisfy the above-mentioned formulae, it is identified as a color image. Here, “N” represents the ambiguity level selected from, for example, a scale of ten by operating a slide bar, as illustrated in FIG. 7.

Once the ambiguity level is selected, as illustrated in FIG. 7, the image is identified as either a color image or a monochrome image based on the selected ambiguity level.

In Step 504 in FIG. 6, the CPU 1 determines whether or not R=G=B. If R=G=B, the CPU 1 determines the image as a monochrome image.

On the other hand, if, in Step 504, the CPU 1 determines that the values of R, G, and B are not equal, the CPU 1 further determines whether or not |R-G|<N, |G-B|<N, and |B-R|<N. If |R-G|<N, |G-B|<N, and |B-R|<N, the image is identified as an ambiguously monochrome image and a flag indicating that the page is an ambiguously monochrome image is added to the top of the page object corresponding to the image. If the image does not satisfy |R-G|<N, |G-B|<N, and |B-R|<N, the CPU 1 determines the image as a color image and adds a color flag to the top of the page object corresponding to the image.

If the ambiguity check was not selected, in Step 506, the CPU 1 determines whether or not R=G=B. If R=G=B, the CPU 1 identifies the image as a monochrome image. If, the CPU 1 determines that the values of R, G, and B are not equal, and the image is identified as a color image.

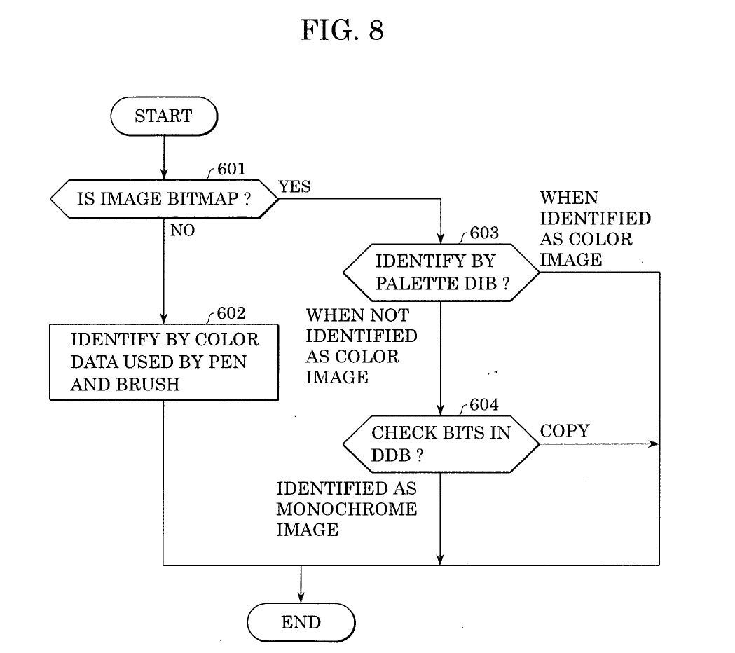

FIG. 8 is a flow chart illustrating a second data processing sequence for a data processing system according to the present invention. FIG. 8 illustrates the details of Step 503 in FIG. 6. This sequence includes Steps 601 to 604.

In Step 601, the CPU 1 determines whether or not the image data for an image is bitmap data. If the CPU 1 identifies that the image data is bitmap data, then, in Step 603, the palette device independent bitmap (palette DIB) is identified as monochrome data or color data. If the image is identified as color data or, in other words, a particular page included in the image data is identified as a color page, the process is ended.

If, in Step 603, the palette DIB is identified as monochrome data, then, in Step 604, the bits of device dependent bitmap (DDB) is checked to determine whether or not the DDB is monochrome data. If the DDB is identified as monochrome data, the entire image data is identified as monochrome data. If the DDB is not identified as monochrome data, the entire image data is identified as color data.

Although not depicted in the drawings, a similar check procedure can be carried out on image data passed through from an application, such as in JPEG pass-through.

In the above-described sequence illustrated in FIG. 8, the pallet DIB and the DDB are checked in separate steps. However, the pallet DIB and the DDB may be checked at once in a single step.

If, in Step 601, the image data is determined not to be bitmap data but to be, for example, text or graphic data, such as diagrams, the color data assigned to a pen or a brush of the application is checked. According to the check results, the image data is identified as color data or monochrome data.

If at least one piece of color graphic data is detected, the sequence is ended.

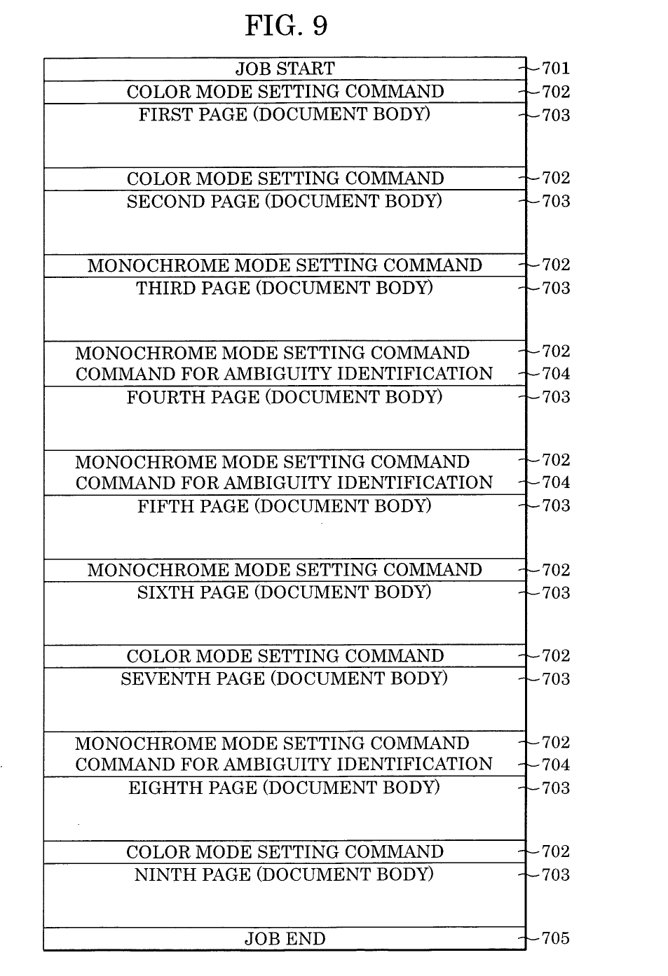

FIG. 9 illustrates page objects of a document managed by the printer driver 203 illustrated in FIGS. 2 and 3.

Each group of fields from a Job Start field 701 to a Job End field 705, as illustrated in FIG. 9, is managed as a single job. Print Mode fields 702 set the print mode for each page 703 included in the body of a document.

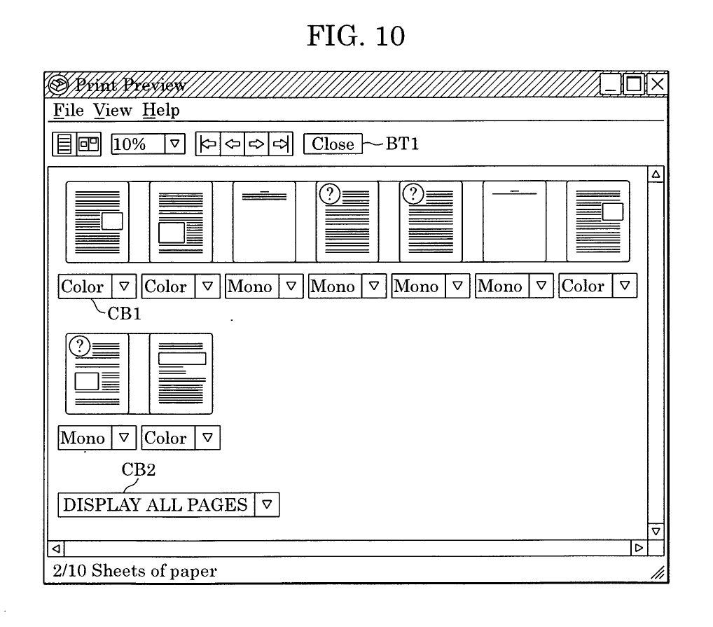

For example, if a page is identified as an ambiguously monochrome page in Step 505 in FIG. 6, a flag indicating that the page is ‘ambiguous’ 704 is attached to the top of the page object corresponding to the page. FIG. 9 illustrates page objects of a document in which the first, second, seventh and ninth pages are determined as color pages, the third and sixth pages are determined as a monochrome page, and the fourth, fifth, and eighth pages are determined as ambiguously monochrome pages. When a flag indicating that the page is ‘ambiguous’ 704 is attached to the top of the page object corresponding to the page, as illustrated in FIG. 10, a question mark (“?”) is added to a thumbnail providing a preview of the page before printing is performed.

Accordingly, a user can click on the thumbnail having the question mark with a pointing device to display an enlarged image. In this way, the user can confirm whether or not the page has been correctly identified as a color page or a monochrome page. If the user wants to change the printing mode selected by the CPU 1 for the page, the combo box CB1 located below the thumbnail corresponding to the page can be operated to select either “Mono” (for monochrome) or “Color,” as illustrated in FIG. 10.

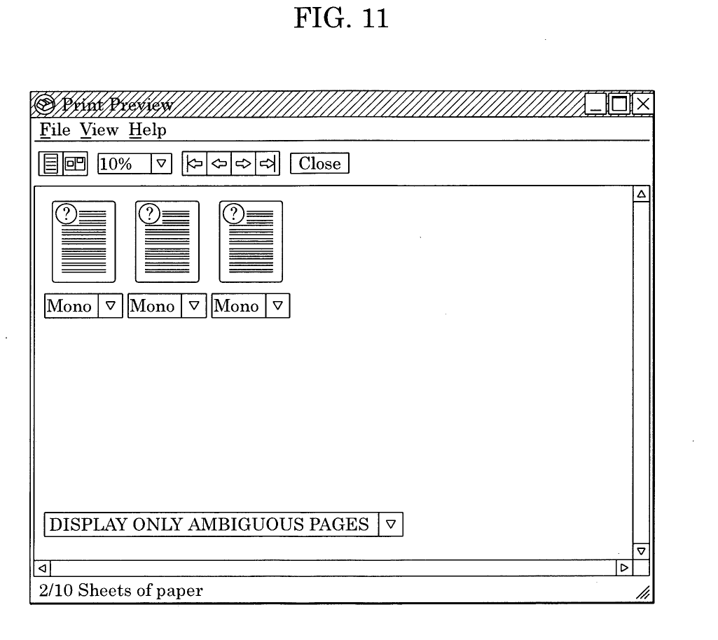

FIGS. 10 and 11 illustrate previews of pages included in a document displayed along with the printing modes for each page selected by the CPU 1 on a CRT 10 of the host computer 3000. FIG. 10 illustrates the previews for all pages, and FIG. 11 illustrates only the pages that have been identified as ambiguously monochrome pages that require confirmation by a user.

In this way, the user can visually confirm the overall data structure of the pages by looking at the preview images of each page.

For example, the user can confirm whether each page includes graphic data, such as photographs, images, and graphic images, or includes only text data. Furthermore, the user can determine whether the page includes color data or includes only monochrome data. In this way, the most suitable printing mode can be efficiently selected.

In the PRINT PREVIEW window for selecting printing modes of each page of a document, all pages are displayed at once, as illustrated in FIG. 10. By operating a combo box CB2, the page display setting can be changed so that only ambiguously monochrome pages are displayed, as illustrated in FIG. 11.

Thumbnails of the pages are displayed as previews. By displaying thumbnails, the pages of the document can be displayed in various sizes so that a user can visibly check every detail of each page to determine whether the page is monochrome or color. In this way, suitable printing modes for each page can be selected.

Below the thumbnail for each page, a combo box for selecting the printing mode (color or monochrome printing mode) CB1 is displayed. If a user wants to change the printing mode of, for example, the first page, the user can change the printing mode by operating the combo box for the first page.

In this embodiment, the CPU 1 identifies a page of a document as a color page, a monochrome page, or an ambiguously monochrome page. For a page identified as an ambiguously monochrome page, a user can check a preview of the page and select the suitable printing mode for the page. However, even if a page is clearly identified as color or monochrome, a user is allowed to change the printing mode. In this way, for example, a document that normally is printed in only black toner can be printed in toners of four different colors (cyan, magenta, yellow, and black) to print the black area in process gray.

When a CLOSE button BT1 in the window illustrated in FIG. 10 is selected and the previews are closed, the printing modes (color or monochrome) selected at this point are reflected onto the page objects.

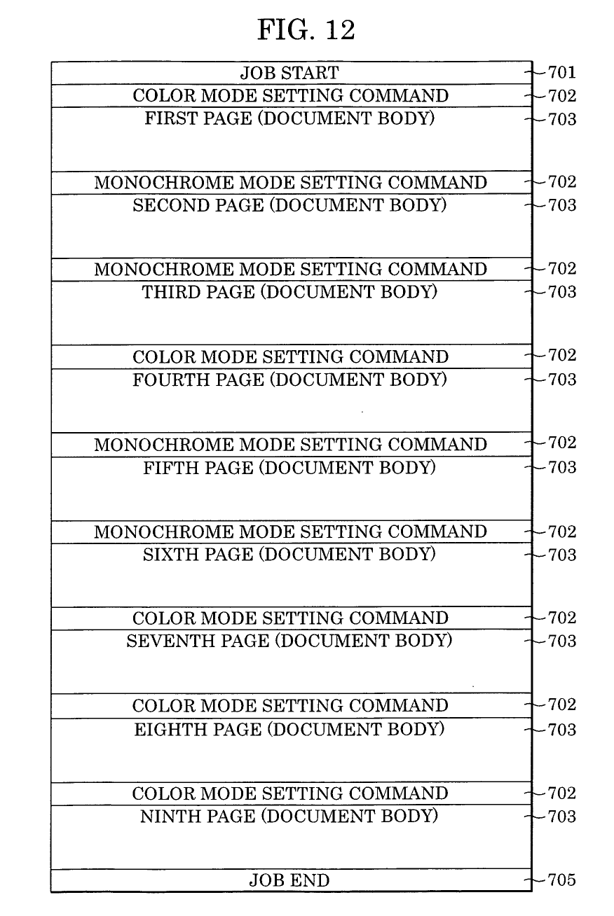

For example, if, for the above-mentioned document, a monochrome printing mode is selected for the printing mode of the second page, color printing modes are selected for the fourth and eighth pages and, then, the CLOSE button BT1 is clicked, the set values for the printing modes for the first, fourth, seventh, eighth, and ninth pages are set to correspond to a color printing mode and the set values for the printing mode for the second, third, fifth, and sixth pages are set to correspond to a monochrome printing mode. These set values are stored in the printing mode fields 702 of the page objects. At this time, the set values in the printing mode fields for all pages may be overwritten or only the set values of the printing mode fields for the pages that have been modified may be overwritten. Flags 704 indicating ambiguity are deleted (changed) at this point. FIG. 12 illustrates a job management table with page objects without the ambiguity flags 704.

FIG. 12 illustrates a management table of page objects of a document managed by the printer driver 203 illustrated in FIGS. 2 and 3. All of the flags 704 indicating ambiguity in the management table illustrated in FIG. 9 have been deleted, and color or monochrome printing modes have been selected for all pages.

In this embodiment, during the printing process, the printer driver 203 creates a color/monochrome setting command based on the printing mode field attached to the top of each page object.

In other words, if the printing mode field for a page object corresponds to a color printing mode, a command for switching on the color printing mode is issued. If the printing mode field for a page object corresponds to a monochrome printing mode, a command for switching on the monochrome printing mode is issued.

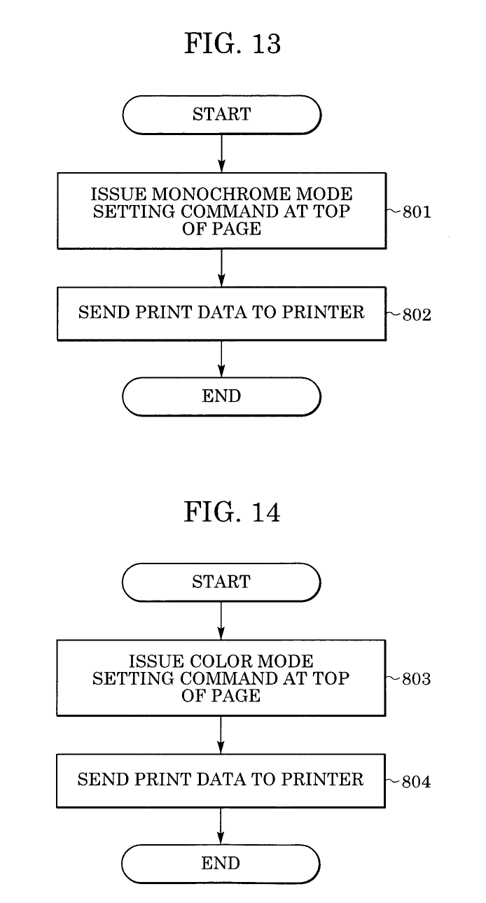

FIG. 13 is a flow chart illustrating a third data processing sequence for a data processor according to the present invention. This sequence corresponds to a data processing process including a process for the printer driver 203 of the host computer 3000 to issue a driver switching command (i.e., a process in which the printer driver 203 issues a printing mode command based on the printing mode field data for each page). The sequence includes Steps 801 and 802.

If a page is identified as monochrome, as described above, the printer driver 203 produces, in Step 801, a monochrome mode setting command (for example, “id_val_color_mode_mono”). In Step 802, print data is sent to the printer 1500 to be processed and, then, the sequence is ended.

FIG. 14 is a flow chart illustrating a fourth data processing sequence for a data processor according to the present invention. This sequence corresponds to the data processing process including a process for the printer driver 203 of the host computer 3000 to issue a driver switching command (i.e., the process in which the printer driver 203 issues a printing mode command based on the printing mode field data for each page). The sequence includes Steps 803 and 804.

If a page is identified as color, as described above, the printer driver 203 produces, in Step 803, a color mode setting command (for example, “id_val_color_mode_color”). In Step 804, print data is sent to the printer 1500 to be processed and, then, the sequence is ended.

In this way, the printer 1500 does not have to determine whether a page is color or monochrome. Therefore, the printing process can be carried out at high speed. Moreover, since the printing mode can also be selected by a user, a document can be reliably processed in suitable printing modes for each page. Therefore, mistakes such as printing a monochrome page in a color printing mode can be prevented.

As described above, when the printer driver 203 automatically identifies the printing mode (color or monochrome printing mode) for each page of a document, a page including image data having equal RGB values is identified as a monochrome page. A page whose differences in the RGB values are below a predetermined value is identified as a monochrome page. However, in such a case, an identifier (flag) indicating that the page is ambiguously monochrome is added to the preview of the page before printing is carried out. If a user does not agree with the automatically selected printing mode (in this case, a monochrome printing mode), the user can change the printing mode on the preview screen. In this way, the page can be printed out in a printing mode in accordance with the user's preference.

Since the printer driver 203 selects the printing mode for each page included in a document, the work load applied to the printer 1500 is reduced. Moreover, in this way, the best mode for printing can be efficiently selected for each page at a preferable timing.

### Second Embodiment

In the first embodiment, if a page of a document was identified as containing ambiguously monochrome image data, the printing mode selected for this page was a monochrome printing mode, and an identifier (question mark (“?”)) was added on the preview image of the page. Instead of selecting a monochrome printing mode in such a case, a color printing mode may be selected, and an identifier (question mark (“?”)) may be added to the preview image of the page.

In other words, the default setting for the printing mode for an ‘ambiguous’ page is a color printing mode for the second embodiment.

More specifically, if the level of ambiguity is selected by operating an AMBIGUITY slide bar in a DETAILED SETTINGS window, as illustrated in FIG. 7, a page is identified as an ambiguously color page when the differences of the values of R, G, and B are below a predetermined value. If the values of R, G, and B are larger than a predetermined value page, the page is identified as a color page.

In other words, if R=G=B, the page is identified as a monochrome page, and if |R-G|<N, |G-B|<N, and |B-R|<N, the page is identified as an ambiguously color page. A page having values of R, G, and B that do not satisfy the above formulae is identified as a color page. Here, “N” represents ambiguity.

If a page is identified as an ambiguously color page, a flag indicating that the page is an ambiguously color image is added to the color printing mode field of the page object.

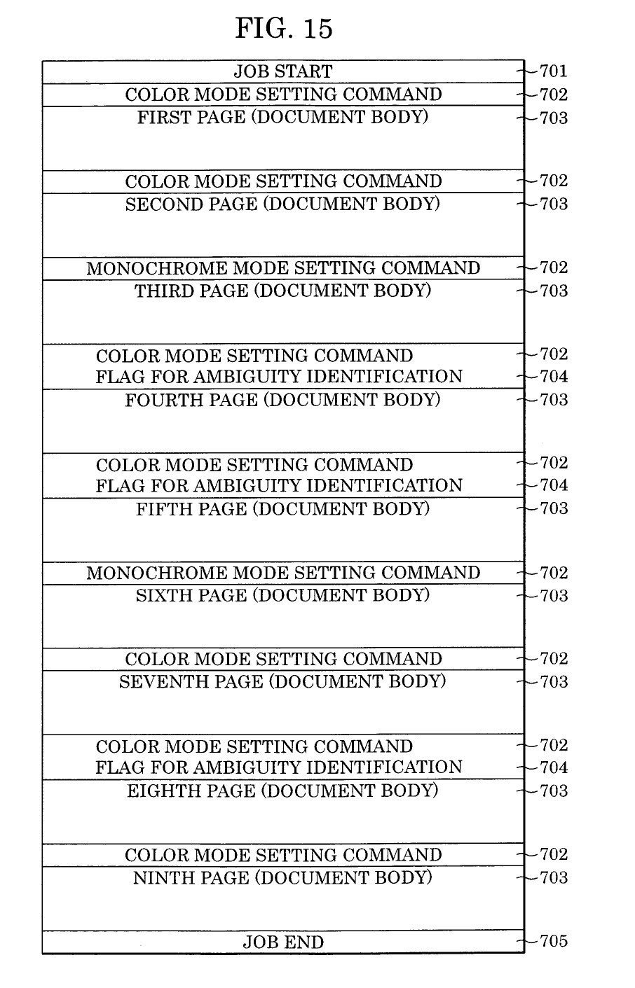

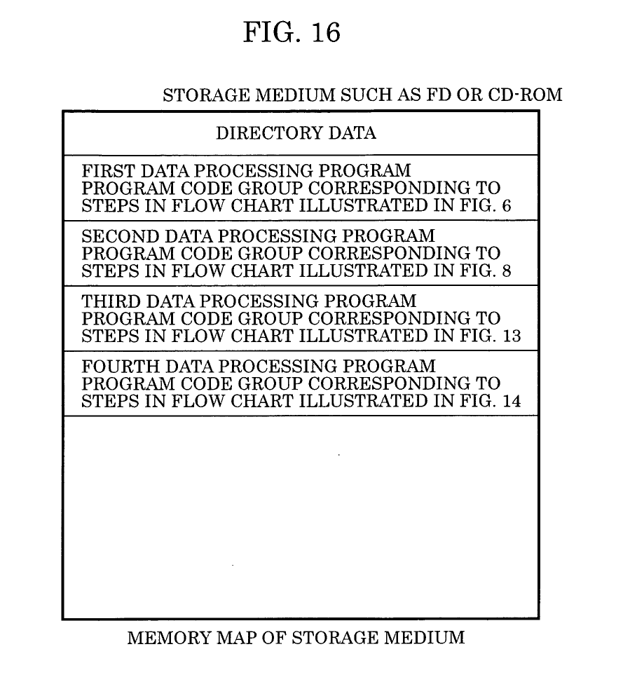

FIG. 15 illustrates another management table for page objects of a document managed by the printer driver 203 illustrated in FIGS. 2 and 3.

FIG. 15 illustrates page objects for pages that have been identified and whose printing modes (color or monochrome) have already been selected.

In FIG. 15, the first, second, seventh, and ninth pages are identified as color pages, the fourth, fifth, and eighth pages are identified as ambiguously color pages, and the third and sixth pages are identified as monochrome pages.

In this way, a page that is unclear whether it is a color page or a monochrome page is identified as a color page and includes an ambiguity flag 704.

FIG. 16 is a schematic view of a memory map of a storage medium for storing various data processing programs readable by the image processor according to the present invention. The storage medium includes a directory and processing code for performing the processes shown in the flowcharts of FIGS. 6, 8, 13 and 14.

### Third Embodiment

In the above-described embodiments, data (page objects) temporarily spooled at the printer driver 203 was identified as color or monochrome data. Then, the result of the identification was sent to the printer driver 203 via DEVMODE so that a color/monochrome mode setting command is issued. However, instead of the printer driver 203, an application may identify whether a set of data is color, monochrome, or ambiguously color or monochrome.

In other words, a mechanism for identifying whether a set of data is color, monochrome, or ambiguously color or monochrome may be included in an application, such as a word processor or spreadsheet. By including such a mechanism in a document processing application, although extendibility of the mechanism is poorer compared to a case in which the mechanism is included in hardware, the mechanism can be specialized for the application. Thus, usability of the mechanism becomes excellent. The identification results obtained by the application is sent to a printer driver by using an application programming interface (API) configuring a printing application.

As described above, when the printer driver automatically identifies the printing mode (color or monochrome printing mode) for a page of document through a color/monochrome identification process according to this embodiment, a page of a document including image data having equal RGB values is identified as a color page. However, by adding an identifier indicating that the page is ambiguously color (or monochrome) to a preview image of the page whose differences in RGB values are below a predetermined value, allows for a user to change the printing mode on the preview screen if the user does not agree with the automatically selected printing mode. In this way, the page can be printed out in a printing mode in accordance with the user's preference.

As many apparently widely different embodiments of the present invention can be made without departing from the spirit and scope thereof, it is to be understood that the invention is not limited to the specific embodiments thereof except as defined in the appended claims.

The exemplary embodiments described above are described with reference to an RGB color space. The present invention is not limited to an RGB color space. The present invention can be applied to any color space. For example the present invention can be applied to a CMY or CMYK color space. In such a case, if C, M and Y are all equal (C=M=Y), the image is identified as a monochrome image. If |C-M|<N, |M-Y|<N, and |Y-C|<N, the image is identified as an ambiguous image. The ambiguous image may be identified as an ambiguous monochrome image (as in the first embodiment) or as an ambiguous color image (as in the second embodiment). If the image does not satisfy the above-mentioned formulae, it is identified as a color image. As in the embodiments described above, “N” represents the ambiguity level. The present invention can be applied to other color spaces. A determination is made as to whether the image is clearly monochrome. As described above, if all of the colors defining the color space are equal, the image is identified as monochrome. If the image is not identified as monochrome, a determination is made as to whether the image is color. As described above, if the difference between any of the colors defining the color space exceeds an ambiguity threshold, the image is identified as a color image. If the differences between all of the colors defining the color space are below an ambiguity threshold (but the differences between all of colors are not all equal to 0, i.e., the image has not been identified as monochrome), the image is defined as ambiguous. As described above, the image may be identified as ambiguously monochrome or the image may be identified as ambiguously color.

When a print driver generates print data from image data, the printing mode for each page of a document can be efficiently selected at a preferable timing. Moreover, if a user does not agree with the automatically selected printing mode, the user can change the printing mode. In this way, according to the present invention, the print data can be output in accordance with the most suitable printing mode.

Accordingly, when a user uses a coin-operated printer, the print data will always be print out in accordance with a printing mode that agrees with the user's decision. In this way, the cost charged for the printouts will be in agreement with the user's estimations.

While the present invention has been described with reference to what exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-022495 filed Jan. 30, 2004, which is hereby incorporated by reference herein.

1. A data processor for processing print data generated from image data by a printer driver capable of communicating with a printer, the data processor comprising:
spool means for converting the image data into intermediate code and temporarily storing the intermediate code in a storage unit, the intermediate code having a data format different from the print data;
criterion selection means for selecting a criterion for identifying the intermediate code as color data or monochrome data;
identification means for identifying the intermediate code as color data or monochrome data based on the criterion selected by the criterion selection means and determining whether identification of the intermediate is ambiguous;
display-controlling means for displaying the intermediate code identified as being ambiguous by the identification means in a way that allows a user to select a printing mode for the intermediate code identified as being ambiguous;
printing-mode selection means for selecting a printing mode for the intermediate code identified as being ambiguous and displayed by the display-controlling means; and
converting means for converting the intermediate code stored in the storage unit into print data in accordance with the printing mode selected by the printing-mode selection means.

2. The data processor according to claim 1, wherein, after the identification means identifies the intermediate code as color data or monochrome data based on the criterion selected by the criterion selection means, the intermediate code identified as being ambiguous is temporarily stored in the storage unit as monochrome data.

3. The data processor according to claim 1, wherein, after the identification means identifies the intermediate code as color data or monochrome data based on the criterion selected by the criterion selection means, the intermediate code identified as being ambiguous is temporarily stored in the storage unit as color data.

4. The data processor according to claim 1, wherein the identifying means adds an identifier indicating that the intermediate code is ambiguous to the intermediate code identified as being ambiguous.

5. The data processor according to claim 1, wherein the display-controlling means displays the intermediate code identified as color data or monochrome data in a different way than the intermediate code identified as being ambiguous, and
the printing-mode selection means allows the print mode for the intermediate code identified as color data or monochrome data to be changed via the intermediate code displayed by the display-controlling means.

6. The data processor according to claim 1, wherein the printer driver is capable of obtaining the printing settings sent from a printing application interface.

7. A method for processing data for a data processor for processing print data generated from image data by a printer driver capable of communicating with a printer, the method comprising:
converting image data into intermediate code and temporarily storing the intermediate code in a storage unit, the intermediate code having a data format different from the print data;
selecting a criterion for identifying the intermediate code as color data or monochrome data;
identifying the intermediate code as color data or monochrome data based on the criterion selected;
determining whether identification of the intermediate code is ambiguous;
displaying the intermediate code identified as being ambiguous in a way that allows a user to select a printing mode for the intermediate code identified as being ambiguous;
selecting a printing mode for the displayed intermediate code identified as being ambiguous; and
converting the intermediate code stored in the storage unit into print data in accordance with the printing mode selected.

8. The method according to claim 7, wherein, after the intermediate code is identified as color data or monochrome data based on the criterion selected, the intermediate code identified as being ambiguous is temporarily stored in the storage unit as monochrome data.

9. The method according to claim 7, wherein, after the intermediate code is identified as color data or monochrome data based on the criterion selected, the intermediate code identified as being ambiguous is temporarily stored in the storage unit as color data.

10. The method according to claim 7, wherein an identifier indicating that the intermediate code is ambiguous is added to the intermediate code identified as being ambiguous.

11. The method according to claim 7, wherein the intermediate code identified as color data or monochrome data is displayed in a different way than the intermediate code identified as being ambiguous, and the print mode for the intermediate code identified as color data or monochrome data is allowed to be changed via the intermediate code displayed.

12. The method according to claim 7, wherein the printer driver is capable of obtaining the printing settings sent from a printing application interface.

13. A method program executed in a data processor for processing print data generated from image data by a printer driver capable of communicating with a printer, the data processing program, comprising:
a spooling step of converting image data into intermediate code and temporarily storing the intermediate code in a storage unit, the intermediate code having a data format different from the print data;
a criterion selection step of selecting a criterion for identifying the intermediate code as color data or monochrome data;
a identifying step of identifying the intermediate code as color data or monochrome data based on the criterion selected in the criterion selection step and determining whether identification of the intermediate code is ambiguous;
a display-controlling step of displaying the intermediate code identified as being ambiguous in the identification step in a way that allows a user to select a printing mode for the intermediate code identified as being ambiguous;
a printing-mode selection step of selecting a printing mode for the intermediate code identified as being ambiguous and displayed in the display-controlling step; and
a converting step for converting the intermediate code stored in the storage unit into print data in accordance with the printing mode selected by the printing-mode selection step.
